(19) United States
(12) Patent Application Publication
(10) Pub. No.: US 2026/0119942 A1
(43) Pub. Date: Apr. 30, 2026

(54) SYSTEMS AND METHODS FOR QUANTA SENSING FOR HIGH-PERFORMANCE QUANTUM COMPUTING

(71) Applicant: Wisconsin Alumni Research Foundation (WARF), Madison, WI (US)

(72) Inventors: Mohit Gupta, Madison, WI (US); Mark Saffman, Madison, WI (US); Andreas Velten, Madison, WI (US); Swamit Tannu, Madison, WI (US)

(21) Appl. No.: 18/926,467

(22) Filed: Oct. 25, 2024

(51) Int. Cl. G06N 10/40

(52) U.S. Cl. CPC G06N 10/40

(57) ABSTRACT

A system and method for quanta sensing is provided. The system includes a quanta sensor, a neutral atom, collection optics, quantum computer, a processor, and a memory. The memory includes instructions stored thereon, which when executed by the processor cause the system to: illuminate the atom array; detect a series of frames of scattered light from the illuminated atom array during a time t; estimate a flux of an image based on the binary frames detected during time t; perform a binary classification based on a flux of the frames; extract quantum state information from the frames; and estimate each neutral atom qubit state based on the extracted quantum state information.

### FIELD OF THE DISCLOSURE

The present disclosure relates to the field of quantum computing and, more particularly, to methods of quanta sensing followed by quanta signal processing and machine learning.

### BACKGROUND

Quantum computers have the potential to unlock new frontiers in science and engineering, addressing critical challenges such as drug development. However, quantum information is fragile, it deteriorates over time and is susceptible to considerable errors. These errors are made worse by the imperfect reading and writing of quantum bits (qubits). Currently, conventional cameras are employed to read qubits, but these are slow and noisy, which significantly limits the execution of quantum programs and could hinder the advancement of quantum computing technology. Thus, achieving fast and accurate qubit readout is crucial for realizing the benefits of quantum computing.

### SUMMARY

An aspect of the present disclosure provides a system for quanta sensing for enabling fast qubit readout in a quantum computer. The system includes a quanta sensor configured for qubit readout, a quantum computer including an atom array comprised of neutral atom qubits; collection optics configured to magnify from an atom plane to a sensor plane; a processor; and a memory. The quanta sensor includes a plurality of detector pixels. The quanta sensor is configured to generate a high-speed sequence of stochastic binary frames or a spatio-temporal stream of photon detections. The memory includes instructions stored thereon, which, when executed by the processor, cause the system to illuminate the atom array, detect a series of frames of scattered light or the spatio-temporal stream of photons from the illuminated atom array during a time t, estimate a flux of an image based on the binary frames or the spatio-temporal stream of photons detected during time t; perform a binary classification of the imaged qubits encoded in the state of the atoms based on a flux of the frames or the spatio-temporal stream of photons; extract quantum state information from the frames; and estimate a qubit state for each neutral atom based on the extracted quantum state information.

In an aspect of the present disclosure, the quanta sensor may include a single photon avalanche diode (SPAD) array.

In another aspect of the present disclosure, light from each atom may be spread over a blur circle determined by a resolution of the collection optics.

In yet another aspect of the present disclosure, the quantum state information may be extracted by providing the frames or the spatio-temporal stream of photons as an input to a machine learning network.

In a further aspect of the present disclosure, the machine learning network may include at least one of an event neural network (ENN) or a spiking neural network (SNN).

In yet a further aspect of the present disclosure, the instructions, when executed by the processor, may further cause the system to generate neutral atom qubit state information based on the SNN and propagate the neutral atom qubit state information asynchronously as discrete spatiotemporal spikes.

In another aspect of the present disclosure, the instructions, when executed by the processor, further cause the system to map each neutral atom of the atom array to a single detector pixel of the plurality of detector pixels.

In yet another aspect of the present disclosure, the instructions, when executed by the processor, may further cause the system to detect a state of each neutral atom of the atom array.

In a further aspect of the present disclosure, the instructions, when executed by the processor, may further cause the system to selectively deactivate pixels of a plurality of pixels of the quanta sensor to match an atom lattice configuration based on the mapped neutral atoms.

In yet a further aspect of the present disclosure, the instructions, when executed by the processor, further cause the system to illuminate each neutral atom of the atom array and count photoelectrons.

In accordance with aspects of the disclosure, there is provided a processor-implemented method for quanta sensing. The method includes illuminating an atom array comprised of neutral atom qubits; detecting, by a quanta sensor, a series of binary frames of scattered light from the illuminated atom array during a time t, wherein the quanta sensor is configured for qubit readout, the quanta sensor including a plurality of detector pixels, wherein the quanta sensor is configured to generate a high-speed sequence of stochastic binary frames; estimating a flux of an image based on the binary frames detected during time t; performing a binary classification of the imaged qubits encoded in the state of the atoms based on a flux of the frames; extracting quantum state information from the frames; and estimating each neutral atom qubit state based on the extracted quantum state information.

In yet another aspect of the present disclosure, the quanta sensor may include a single photon avalanche diode (SPAD) array.

In a further aspect of the present disclosure, light from each atom may be spread over a blur circle determined by a resolution of collection optics which are configured to magnify from an atom plane to a sensor plane.

In yet a further aspect of the present disclosure, the quantum state information may be extracted by providing the frames as an input to a machine learning network.

In a further aspect of the present disclosure, the machine learning network may include at least one of an event neural network (ENN) or a spiking neural network (SNN).

In yet a further aspect of the present disclosure, the method may further include generating neutral atom qubit state information based on the SNN and propagating the neutral atom qubit state information asynchronously as discrete spatiotemporal spikes.

In a further aspect of the present disclosure, the method may further include mapping each neutral atom of the atom array to a single detector pixel of the plurality of detector pixels.

In yet a further aspect of the present disclosure, the method may further include detecting a state of each neutral atom of the atom array.

In yet a further aspect of the present disclosure, the method may further include selectively deactivating pixels of a plurality of pixels of the quanta sensor to match an atom lattice configuration based on the mapped neutral atoms.

In accordance with aspects of the disclosure, there is further provided a non-transitory computer-readable medium storing a program that causes a computer to execute a processor-implemented method for quanta sensing. The method includes illuminating an atom array comprised of neutral atom qubits; detecting, by a quanta sensor, a series of binary frames of scattered light from the illuminated atom array during a time t, wherein the quanta sensor is configured for qubit readout, the quanta sensor including a plurality of detector pixels, wherein the quanta sensor is configured to generate a high-speed sequence of stochastic binary frames; estimating a flux of an image based on the binary frames detected during time t; performing a binary classification of the imaged qubits encoded in the state of the atoms based on a flux of the frames; extracting quantum state information from the frames; and estimating each neutral atom qubit state based on the extracted quantum state information.

### BRIEF DESCRIPTION OF THE DRAWINGS

A better understanding of the features and advantages of the present disclosure will be obtained by reference to the following detailed description that sets forth illustrative aspects, in which the principles of the present disclosure are utilized, and the accompanying drawings of which:

FIG. 1 is a block diagram illustrating an exemplary system for quanta sensing for quantum computers, in accordance with examples of the present disclosure;

FIG. 2 is a schematic diagram of an exemplary processing system diagram for use with the system of FIG. 1, in accordance with aspects of the present disclosure;

FIG. 3 is a block diagram illustrating an exemplary physical setup for a quanta-sensor-enabled quantum computer for use with the system of FIG. 1, in accordance with aspects of the present disclosure;

FIG. 4 is a diagram illustrating quanta sensing and processing for quantum computing for use with the system of FIG. 1, in accordance with aspects of the present disclosure;

FIG. 5 is a flow diagram of a method for quanta sensing for quantum computers of FIG. 1, in accordance with aspects of the present disclosure; and

FIG. 6A depicts a graphic illustration of a CMOS image, in accordance with aspects of the present disclosure;

FIG. 6B. depicts a graphic illustration of an SPAD image where a number of samples (n)=1, in accordance with aspects of the present disclosure;

FIG. 6C depicts a graphic illustration of SPAD image where n=2, in accordance with aspects of the present disclosure; and

FIG. 6D depicts a graphic illustration of SPAD image where n=10, in accordance with aspects of the present disclosure.

### DETAILED DESCRIPTION

Although the present disclosure will be described in terms of specific examples, it will be readily apparent to those skilled in this art that various modifications, rearrangements, and substitutions may be made without departing from the spirit of the present disclosure. The scope of the present disclosure is defined by the claims appended hereto.

For purposes of promoting an understanding of the principles of the present disclosure, reference will now be made to exemplary aspects illustrated in the drawings, and specific language will be used to describe the same. It will nevertheless be understood that no limitation of the scope of the present disclosure is thereby intended. Any alterations and further modifications of the novel features illustrated herein, and any additional applications of the principles of the present disclosure as illustrated herein, which would occur to one skilled in the relevant art and having possession of this disclosure, are to be considered within the scope of the present disclosure.

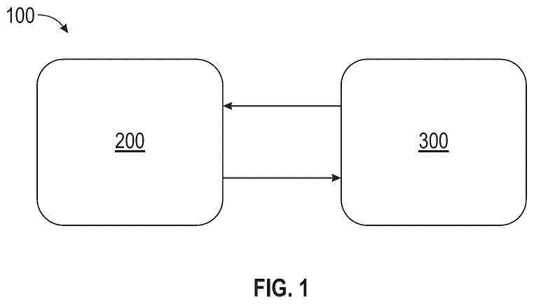

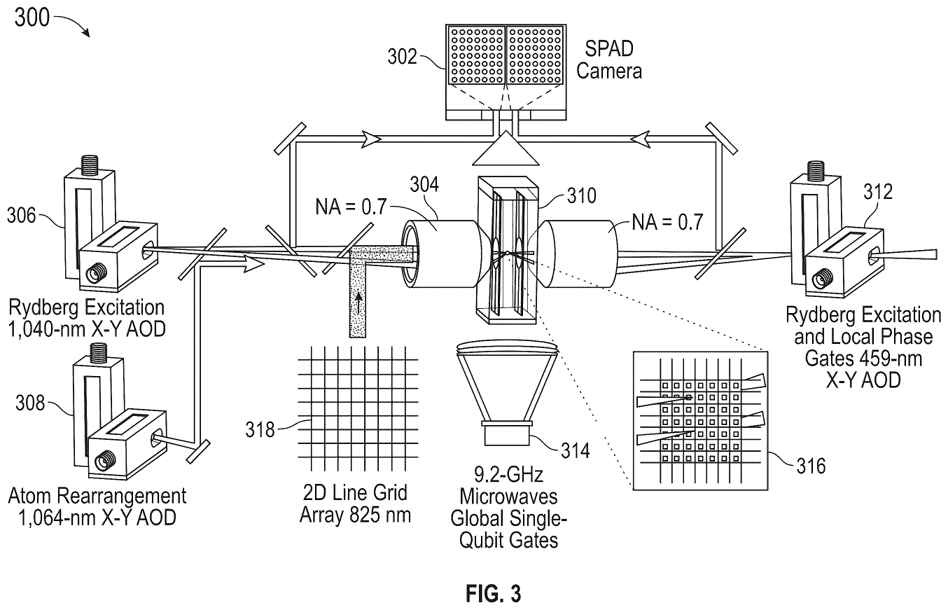

Referring to FIGS. 1 and 3, block diagrams illustrating a system 100 for quanta sensing are shown. System 100 generally includes a quantum computer 300 (e.g., a neutral atom quantum computer and/or a trapped ion based quantum computer), a quanta sensor 302 (FIG. 3), collection optics 304 (FIG. 3), and a controller 200 (e.g., a classical computer). System 100 is configured to enable qubit readout using high-speed single photon avalanche diodes (SPAD) arrays (quanta sensor 302). System 100 may further include an illumination source. The collection optics 304 are configured to magnify from an atom plane to a sensor plane.

The quanta sensor 302 (e.g., a single photon avalanche diode array) is configured for qubit readout. The quanta sensor 302 generally includes a plurality of detector pixels. The quanta sensor is configured to generate a high-speed sequence of stochastic (Bernoulli) binary frames or a spatio-temporal stream of photon detections based on light scattered from a qubit (e.g., a neutral atom qubit) or qubit array.

In aspects, the system 100 may include a laser source configured for Rydberg excitation 306, for atom rearrangement 308, and/or Rydberg excitation and local phase gates 312. For example, the laser source may be a 1040 nm beam directed through an acousto-optical deflector (AOD) for scanning.

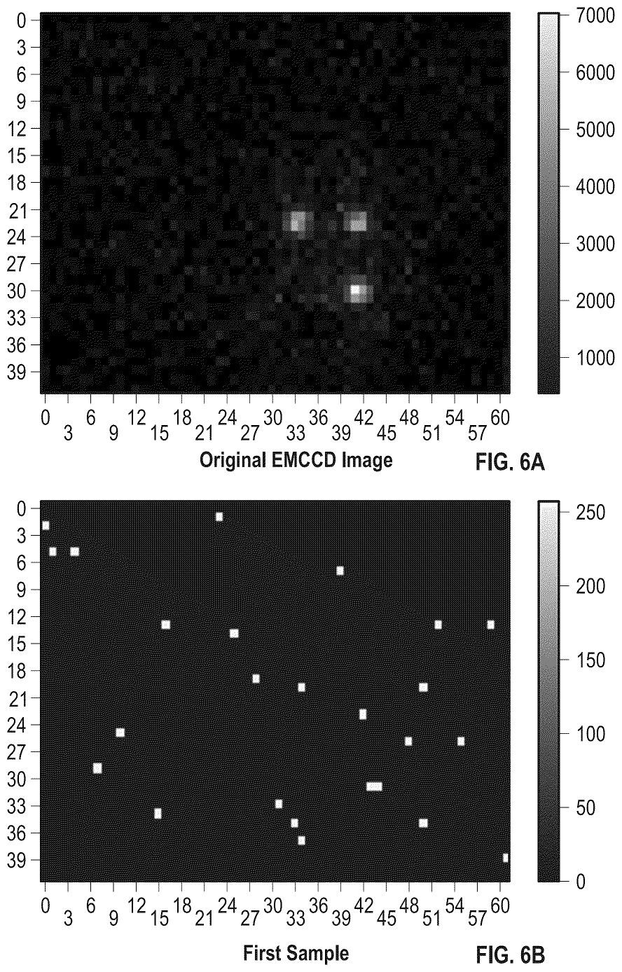

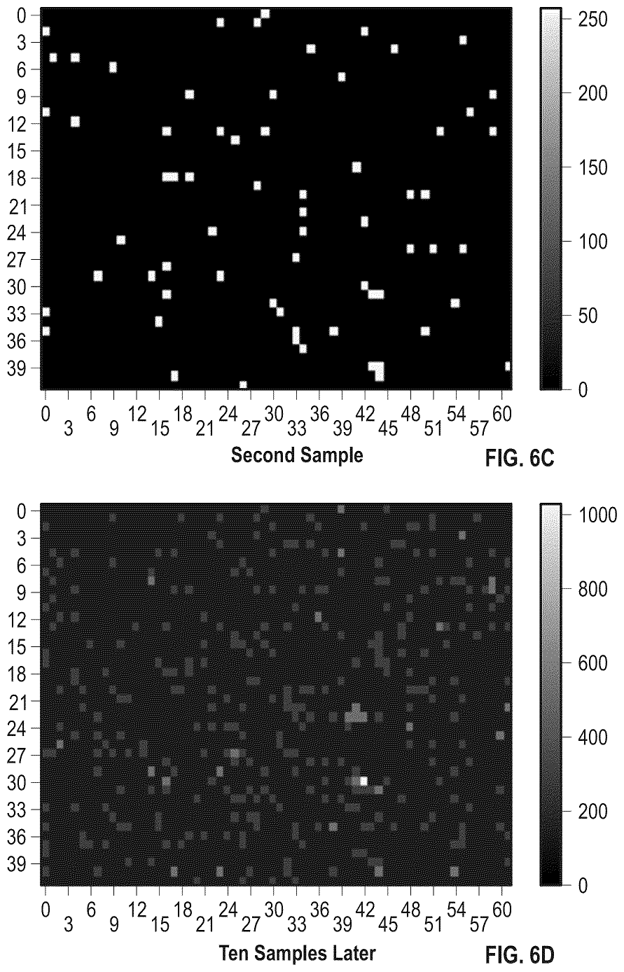

Quanta sensors detect individual photons scattered from qubits. Single photon avalanche diodes (SPADs) fall into that category. System 100 leverages the use of quanta (single photon) sensors for fast and accurate qubit readout. Quanta sensors detect the location and arrival time of individual photons, thus enabling direct sensing of quantum states from photons two to three orders of magnitude faster than CMOS sensors (FIG. 6A) (a few microseconds versus a few milliseconds), thereby transforming the capabilities (speed, accuracy) of future quantum computers. Quanta sensors based on Single Photon Avalanche Detector (SPAD) arrays with near megapixel resolution are already available and are rapidly becoming the sensor-of-choice in scientific instruments, robots, cars, and even cell phones. State of the art SPAD arrays combine low dark count and extremely fast readout rates, which will enable high-speed, high-accuracy qubit state measurements while preventing crosstalk and minimizing deleterious atom-heating effects during mid-circuit measurements.

The physical layer of hardware of neutral atom quantum computers is designed where qubit readout is performed by high-speed SPAD arrays.

Signal-processing and machine learning (ML) techniques are utilized for extracting quantum state information from the spatio-temporal photon sequences captured by SPAD arrays in the form of high-speed sequences of Bernoulli binary frames.

Error corrected quantum computers use a collection of noise-prone physical qubits to construct logical qubits. Logical qubits can correct computational errors by initializing a subset of the physical qubits to compute, measure, and decode the parity information. This cycle of initialize-compute-measure-decode is continuously repeated, and the faster this cycle runs, the more effective the error correction. Qubit initialization and parity measurement require imaging atomic arrays, which currently operate at the hundred microseconds to millisecond time scales. System 100 solves this technical problem by leveraging a SPAD which can speed up the readout by orders of magnitude, improving QEC efficacy.

The use of quanta (single-photon) sensors in accordance with the present disclosure provides fast and accurate qubit readout. This enables sensing qubits at two to three orders of magnitude higher speeds (few microseconds from about 10 milliseconds), thereby transforming the capabilities (speed, accuracy) of future quantum computers, and for the first time, paving the way for scalable and practical quantum computing.

The imaging of system 100 has applications, for example, in lattice preparation (e.g., imaging and rearranging atoms) and in a quantum error correction loop (e.g., when measuring parity bits).

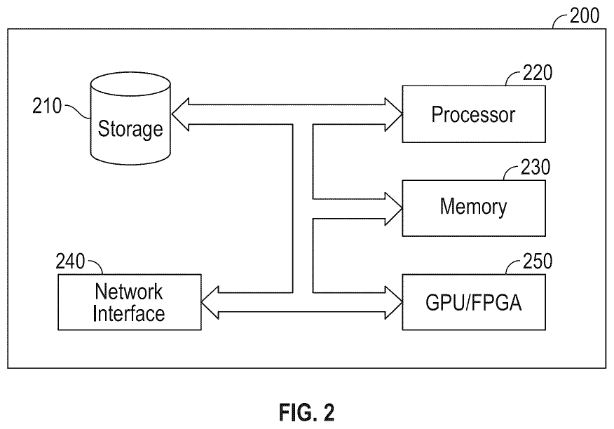

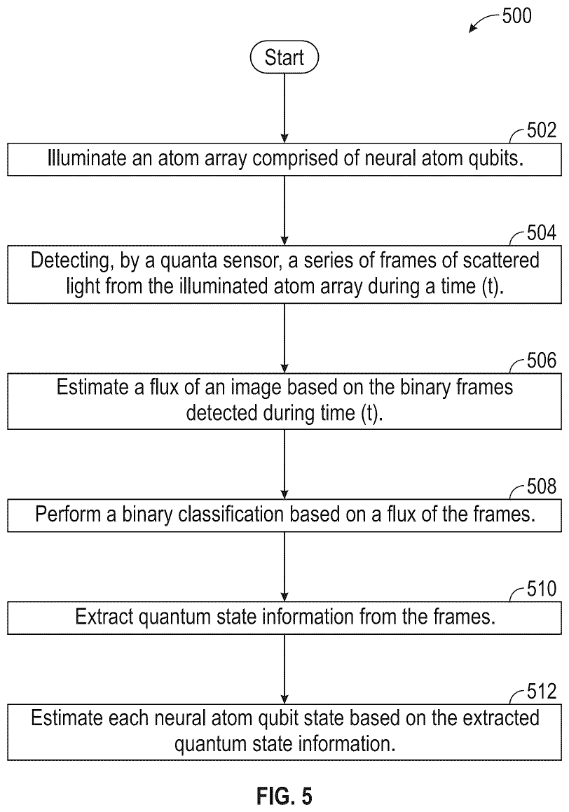

Referring now to FIG. 2, exemplary components of the controller 200 are shown. The controller 200 generally includes a storage or database 210, one or more processors 220, at least one memory 230, and a network interface 240. In aspects in accordance with the present disclosure, the controller 200 may include a graphical processing unit (GPU) 250. The processor 220 and a memory 230 include instructions stored thereon, which, when executed by the processor 220, cause the system 100 to perform the steps of method 500 of FIG. 5.

The database 210 can be located in storage. The term “storage” may refer to any device or material from which information may be capable of being accessed, reproduced, and/or held in an electromagnetic or optical form for access by a computer processor. Storage may be, for example, volatile memory such as RAM, non-volatile memory, which permanently holds digital data until purposely erased, such as flash memory, magnetic devices such as hard disk drives, and optical media such as a CD, DVD, Blu-ray Disc™, or the like.

In aspects, data may be stored on the controller 200, including, for example, user accounts, permissions, licensing documentation, and/or other data. The data can be stored in the database 210 and sent via a system bus to the processor 220.

As will be described in more detail later herein, the processor 220 executes various processes based on instructions that can be stored in the at least one memory 230 and utilizing the data from the database 210. The illustration of FIG. 2 is exemplary, and persons skilled in the art will understand that other components may exist in controller 200. Such other components are not illustrated for clarity of illustration.

Neutral atom qubits can be encoded in two hyperfine states of a ground electronic configuration. These states have excellent coherence properties that have been observed to reach close to one minute. Rapid state selective measurements of atomic qubits can be made by illuminating the atom with light tuned that couples one of the hyperfine states to an electronically excited state. After excitation, the atom decays emitting a photon, and can then be re-excited. In this way, many photons are scattered if the atom is in the resonant state, which is referred to as a bright state |b [symbol] . If instead the atom is in the non-resonant hyperfine state, it will not be excited and will stay dark, which is referred a dark state |d [symbol] .

Currently, conventional EMCCD cameras are used for reading qubit states by sensing photons scattered from atoms. This is slow and error-prone due to the fundamental limitations (high noise, low speed) of EMCCD sensors. To decrease noise and increase speed, a new class of neutral atom quantum computers are utilized where qubits are read by quanta sensors. Quanta sensors detect individual photons, thus enabling high-speed direct sensing of quantum states from photons.

Referring to FIG. 3, a diagram illustrating a physical setup for a quanta-sensor (SPAD) enabled quantum computer 300 is shown. Despite their single-photon sensitivity, a key limitation of SPAD arrays is the relatively low fill-factor due to the necessity of placing a guard ring 1 around each SPAD pixel. In current CMOS technologies, due to the guard ring, SPAD pitch cannot be reduced below 1 [symbol] . At that pitch, the guard ring occupies a large portion of the pixel, thus reducing the fill factor to a minimum. For example, a SPAD array may have a fill factor of 10.5% with 3 μm radius circular pixels.

Although the small fill factor limits the applicability of SPAD arrays in robotics (due to low efficiency), it turns out to be very well matched to the imaging of atomic arrays due to the small size of the atoms.

Based on this observation, a physical layer design is utilized, which includes a physical setup for a quanta-sensor (SPAD) 302 enabled quantum computer 300. For example, an atomic array 316 may be a 1225 site atomic array. The atoms may be, for example, spaced on a grid 318 with, for example, a pitch of 3 μm. The array 316 may be implemented using an optical technique. Collection optics 304 with magnification of about five times are used from the atom plane to the SPAD plane so that each atom is mapped onto a single detector pixel. The light from each atom will be spread over a blur circle determined by the resolution of the imaging optics, which is about 1 [symbol] . Thus, the light from each atom will be efficiently collected by a single SPAD pixel.

In addition to the low fill factor, another hardware-level challenge is the high dark count rate (rate of spurious SPAD detections unrelated to photons), which could lead to large errors in qubit state estimation. While the dark count rate of SPAD cameras is typically reported as an average over an entire array, the rates of individual pixel vary widely due to impurities. In most devices, a small fraction of “hot” pixels is permanently deactivated as they contribute no useful signal, and their excessive dark counts take up bandwidth and can couple into neighboring pixels.

In the quantum computing application, there are more pixels (e.g., about 105) than atoms (e.g., about 103 to 104). Based on these observations, low dark-count pixels are identified and the lattice of atoms are matched to a sub-set of SPAD pixels with low overall noise. This can be implemented by leveraging the flexibility of atom arrangement using optical trapping, and the long-range nature of the atomic Rydberg interaction, allowing the atom layout to be modified as needed to avoid the noisy pixels. These atom-to-pixel matching policies can be designed to avoid crosstalk to allow for unoccupied and deactivated pixels between active ones. With such policies and with appropriate firmware access, pixels can be selectively deactivated to match various atom lattice configurations to achieve optimal performance.

It is of interest to estimate the time for performing a qubit state measurement with a desired accuracy. The number of photoelectron counts recorded in a measurement time t when the atom is in the bright state is:

$$q ( τ ) = {r}_{s} ( η \frac{{Ω}_{d}}{4 π} ) τ . \qquad Eqn . ( 1 )$$

where the atomic scattering rate is

$${r}_{s} = \frac{γ}{2} \frac{I / {I}_{s}}{1 + 4 \frac{4 {Δ}^{2}}{{γ}^{2}} + I / {I}_{s}} ( {s}^{- 1} ) . \qquad Eqn . ( 2 )$$

The scattering rate depends on the intensity of the readout light I, the atomic saturation intensity Is, the detuning from the atomic transition A, and the atomic excited state decay rate γ. The factor in parentheses in Eq. (1) determines the efficiency with which scattered photons are converted into detected photoelectrons. The efficiency factor depends on the solid angle of the light collection optics Ω_{d}, and the quantum efficiency n=η_{d}ηₗₒₛₛ, which accounts for the detector efficiency η_{d}, and any optical losses ηₗₒₛₛ.

When the atom is in the dark state it does not scatter any photons but photoelectron counts will accumulate due to detector dark counts and background light scattering. Assuming that the background light scattering is negligible, the mean background count number is b(τ)=b₀τ. When the atom is in the bright state the mean count number is q(τ)+b(τ).

Both the signal and background counts are assumed Poisson distributed so that the probability of measuring n counts is

$${P}_{n} ( r ) = {e}^{- r} {r}^{n} / n ! and {\sum }_{n = 0}^{∞} n {P}_{n} ( r ) = r ,$$

the mean count rate. To make a measurement the atom and count photoelectrons are illuminated for a time τ. If the number of counts is greater than or equal to a cutoff number n_{c} the qubit is measured to be in state |b [symbol] . The measurement is incorrect if the atom was in state |b [symbol] and the number of detected counts was less than n_{c} or the atom was in state |d [symbol] and the number of counts was greater than or equal to n_{c}. In addition to the Poisson distributed signal and background, dark counts that gives a normally distributed counting probability is:

$$g ( \tilde{n} ) \text{?} = \frac{1}{\sqrt{\text{?} 2 πσ}} {e}^{- {( \tilde{n} - μ )}^{2} / {σ}^{2}}$$

$$\text{?} \text{indicates text missing or illegible when filed}$$

with mean μ and variance σ². The probability of a measurement error is therefore:

$$\begin{matrix}E ( τ ) = {P}_{dark} \text{?} {P}_{n} ( b ) + {P}_{bright} \text{?} {\sum }_{{n}^{′} = 0}^{n} {P}_{{n}^{′}} ( q ) {P}_{n - {n}^{′}} ( b ) \\ = {P}_{dark} [ 1 - \frac{Γ ( {n}_{c} , b )}{Γ ( {n}_{c} )} ] + {P}_{bright} \frac{Γ ( {n}_{c} , q + b )}{Γ ( {n}_{c} )}\end{matrix} ,$$

$$\text{?} \text{indicates text missing or illegible when filed}$$

where P_{dark}, P_{bright} are the probabilities that the atom is in the dark or bright states, Γ(n_{c})=(n_{c}−1)!, and

$$Γ ( {n}_{c} , q ) = {\int }_{q}^{∞} dt {t}^{{n}_{c} - 1} {e}^{- t}$$

is the incomplete gamma function. Since Γ(n_{c}, 0)=Γ(n_{c}) the dark state error vanishes when b→0. For given values of q(τ), b(τ), and τ, there is an optimum choice of n_{c} that minimizes the error.

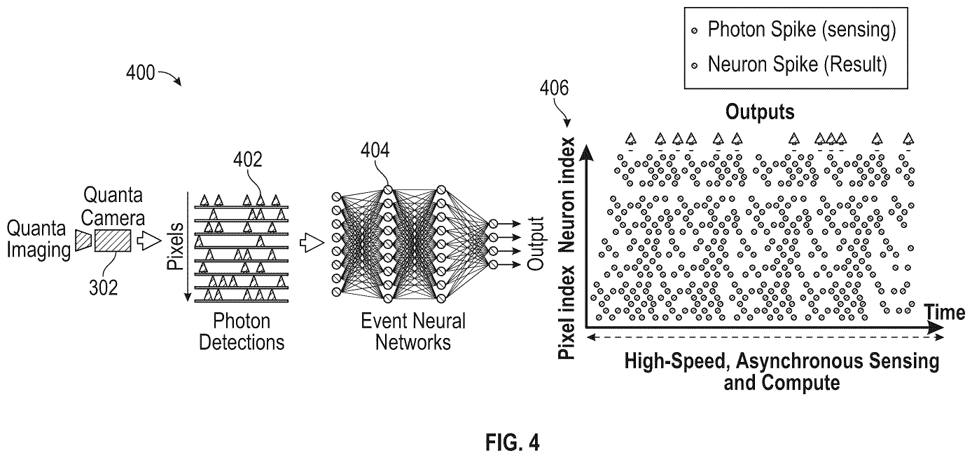

Referring to FIG. 4, a diagram illustrating quanta sensing and processing 400 for quantum computing is shown.

The raw data captured by SPADs is a high-speed sequence of stochastic (Bernoulli) binary (1-bit) frames, and thus fundamentally different from conventional camera images. Conventional deep learning algorithms have evolved for images in the form of 2D arrays of continuous values and are, therefore, incompatible with the unconventional single-photon data. As a result, quanta computational imaging may be utilized, which includes a new class of statistical and machine learning techniques for extracting quantum state information from the spatio-temporal photon sequences captured by SPADs. This is based on re-designing, from first principles, the hierarchy of computational algorithms, starting from low-level signal processing to high-level machine learning, while incorporating the physics of single-photon imaging.

The proposed quanta imaging framework involves both aspects of the imaging system, that is, sensing and processing, in terms of discrete, asynchronous information packets. The machine learning network 404 may include event neural networks (ENNs) and spiking neural networks (SNN), a class of neural networks where neurons exchange information in the form of a temporal sequence of discrete spikes, instead of continuous values as in conventional neural networks. Each spike denotes an event, and the information is encoded in the frequency and timing of spikes. Given their discrete and asynchronous spike-based information processing, SNNs are natural candidates for processing photon-cube data, which in itself can be viewed as a train of spikes.

In the quanta processing framework, qubit state information is captured and propagated asynchronously as discrete spatio-temporal spikes, starting from sensing (photon-cube data) through processing to the final output 406, as shown in FIG. 4.

In addition to the low-level imaging benefits of SPADs (single-photon sensitivity, high-speeds), a quanta processing system consisting of a SPAD and machine learning network 404 (e.g., an ENN and/or SNN) can achieve pseudo-instantaneous information processing, which means that an approximate output is available immediately after recording the first input photon-spikes. This enables fast (albeit potentially less precise) qubit state estimation and QEC. In contrast, a conventional camera and a conventional neural network (CNN) form a synchronous processing pipeline. The final output is available only after the entire data passes through all the network layers. Such a synchronous pipeline is not amenable to speed-critical tasks where every microsecond is at a premium, especially where deep (>100 layers) architectures are used. The disclosed system solves these technical problems by enabling fast qubit state estimation and QEC.

System 100 enables exploiting timing information based on photon detections and neuron activations. SPADs have the ability to time-tag incident photons with picosecond precision. As a result, not only do SPAD arrays have extremely high sensitivity, but the captured photon cube has an additional time dimension, a rich source of scene information that is inaccessible to conventional cameras. For example, inter-photon timing measurements captured by a SPAD array enable high dynamic range imaging, reaching up to a dynamic range of over ten million to one. System 100 can maintain and exploit this timing information throughout the post-processing and ML algorithm stack for qubit state estimation.

In aspects, the SNN enables information coding. The system 100 leverages the rich information embedded in the timing of spikes as well as the average rate (count) of spikes to convey the activation of spikes. While sufficient for input spike trains that are perfectly described by a Poisson process, it is not directly applicable for photon-cube input data, which does not follow Poisson distribution due to SPAD dead-time. System 100 encodes and propagates information in SNNs for photon-cube input data by using temporal spike codes to represent spiking activity in an SNN. This enables representing qubit state information that is challenging to represent with just the count of spikes generated by neurons.

The system 100 may extract information from raw photon-cube data by reading the entire data from the SPAD array and then performing relevant computations using controller 200.

To avoid transferring the entire photon-cube, computations may be performed near sensor. As a result, computing projections on-chip reduces sensor readout and latency. Along similar lines, customized single-photon compute architectures, sensors (SPAD arrays), and downstream processing algorithms are proposed to maximize qubit state estimation accuracy while minimizing latency, even as the number of qubits scales up dramatically in future quantum computers.

Referring to FIG. 5, a method 500 for logical patch synchronization for quantum computers using the system of FIG. 1 is shown. The system 100 for logical patch synchronization for quantum computers may include a processor and a memory, including instructions stored thereon, which when executed by the processor 220, cause the quantum computer 300 to perform the steps of method 500. Some operations may be performed on a classical computer, such as controller 200.

Initially, at step 502, the processor causes the system 100 to illuminate an atom array comprised of neutral atom qubits. For example, the neutral atom qubits are illuminated for a time t.

At step 504, the processor causes the system 100 to detect, by a quanta sensor, a series of frames of scattered light from the illuminated atom array during a time t. In aspects, the quanta sensor includes a SPAD array configured to generate a high-speed sequence of stochastic binary frames. Light from each atom is spread over a blur circle determined by a resolution of the collection optics. In aspects, The SPAD array may be configured to generate a spatio-temporal stream of photon detections, where each photon detection carries its timestamp and location. The spatio-temporal series of photon detections carry fine-grained flux information, and enables a more reliable and higher-speed qubit state estimation.

At step 506, the processor causes the system 100 to estimate a flux of an image based on the binary frames detected during time τ.

In aspects, the processor may cause the system 100 to map each neutral atom of the atom array to a single detector pixel of a plurality of detector pixels of the SPD. In aspects, the processor may cause the system 100 to selectively deactivate pixels of a plurality of pixels of the quanta sensor to match an atom lattice configuration based on the mapped neutral atoms

At step 508, the processor causes the system 100 to perform a binary classification of the imaged qubits encoded in the state of the atoms based on a flux of the frames.

At step 510, the processor causes the system 100 to extract quantum state information from the frames. In aspects, the quantum state information is extracted by providing the frames as an input to a machine learning network 404 (FIG. 4), for example an event neural network (ENN) and/or a spiking neural network (SNN). In aspects, the processor may cause the system 100 to generate neutral atom qubit state information based on the SNN and propagate the neutral atom qubit state information asynchronously as discrete spatiotemporal spikes.

At step 512, the processor causes the system 100 to estimate a qubit state for each neutral atom based on the extracted quantum state information.

FIGS. 6B-6D depict SPAD images using various amounts of samples. For example, For example, FIG. 6B illustrates one sample (n=1), FIG. 6C illustrates two samples (n=2), and FIG. 6D illustrates 10 samples (n=10).

The aspects disclosed herein are examples of the disclosure and may be embodied in various forms. For instance, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an aspect,” “in aspects,” “in various aspects,” “in some aspects,” or “in other aspects” may each refer to one or more of the same or different example aspects provided in the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The aspects described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A system for quanta sensing, comprising:
a quanta sensor configured for qubit readout, the quanta sensor including a plurality of detector pixels, wherein the quanta sensor is configured to generate at least one of a high-speed sequence of stochastic binary frames or a spatio-temporal stream of photon detections where each photon detection carries a timestamp and a location;
a quantum computer including an atom array comprised of neutral atom qubits;
collection optics configured to magnify from an atom plane to a sensor plane;
a processor; and
a memory, with instructions stored thereon, which, when executed by the processor, cause the system to:
illuminate the atom array;
detect the series of binary frames of scattered light or the spatio-temporal stream of photons from the illuminated atom array during a time t;
estimate a flux of an image based on the binary frames or the spatio-temporal stream of photons detected during time t;
perform a binary classification of the imaged qubits encoded in the state of the atoms based on a flux of the frames or the spatio-temporal stream of photons;
extract quantum state information from the frames or the spatio-temporal stream of photons; and
estimate a qubit state for each neutral atom based on the extracted quantum state information.

2. The system of claim 1, wherein the quanta sensor includes a single photon avalanche diode (SPAD) array.

3. The system of claim 1, wherein light from each atom is spread over a blur circle determined by a resolution of the collection optics.

4. The system of claim 1, wherein the quantum state information is extracted by providing the frames or the spatio-temporal stream of photons as an input to a machine learning network.

5. The system of claim 4, wherein the machine learning network includes at least one of an event neural network (ENN) or a spiking neural network (SNN).

6. The system of claim 5, wherein the instructions, when executed by the processor, further cause the system to:
generate neutral atom qubit state information based on the SNN; and
propagate the neutral atom qubit state information asynchronously as discrete spatiotemporal spikes.

7. The system of claim 1, wherein the instructions, when executed by the processor, further cause the system to:
map each neutral atom of the atom array to a single detector pixel of a plurality of detector pixels of the SPD.

8. The system of claim 7, wherein the instructions, when executed by the processor, further cause the system to:
detect a state of each neutral atom of the atom array.

9. The system of claim 7, wherein the instructions, when executed by the processor, further cause the system to:
selectively deactivate pixels of a plurality of pixels of the quanta sensor to match an atom lattice configuration based on the mapped neutral atoms.

10. The system of claim 1, wherein the instructions, when executed by the processor, further cause the system to:
illuminate each neutral atom of the atom array and count photoelectrons.

11. A processor-implemented method for quanta sensing, comprising:
illuminating an atom array comprised of neutral atom qubits;
detecting, by a quanta sensor, a series of binary frames of scattered light from the illuminated atom array during a time t, wherein the quanta sensor is configured for qubit readout, the quanta sensor including a plurality of detector pixels, wherein the quanta sensor is configured to generate a high-speed sequence of stochastic binary frames;
estimating a flux of an image based on the binary frames detected during time t;
performing a binary classification of the imaged qubits encoded in the state of the atoms based on a flux of the frames;
extracting quantum state information from the frames; and
estimating each neutral atom qubit state based on the extracted quantum state information.

12. The method of claim 11, wherein the quanta sensor includes a single photon avalanche diode (SPAD) array.

13. The method of claim 11, wherein light from each atom is spread over a blur circle determined by a resolution of collection optics which are configured to magnify from an atom plane to a sensor plane.

14. The method of claim 11, wherein the quantum state information is extracted by providing the frames as an input to a machine learning network.

15. The method of claim 14, wherein the machine learning network includes at least one of am event neural network (ENN) or a spiking neural network (SNN).

16. The method of claim 15, further comprising
generating neutral atom qubit state information based on the SNN; and
propagating the neutral atom qubit state information asynchronously as discrete spatiotemporal spikes.

17. The method of claim 11, further comprising
mapping each neutral atom of the atom array to a single detector pixel of the plurality of detector pixels.

18. The method of claim 17, further comprising
detecting a state of each neutral atom of the atom array.

19. The method of claim 17, further comprising
selectively deactivating pixels of a plurality of pixels of the quanta sensor to match an atom lattice configuration based on the mapped neutral atoms.

20. A non-transitory computer-readable medium storing a program that causes a computer to execute a processor-implemented method for quanta sensing, comprising:
illuminating an atom array comprised of neutral atom qubits;
detecting, by a quanta sensor, a series of binary frames of scattered light from the illuminated atom array during a time t, wherein the quanta sensor is configured for qubit readout, the quanta sensor including a plurality of detector pixels, wherein the quanta sensor is configured to generate a high-speed sequence of stochastic binary frames;
estimating a flux of an image based on the binary frames detected during time t;
performing a binary classification of the imaged qubits encoded in the state of the atoms based on a flux of the frames;
extracting quantum state information from the frames; and
estimating each neutral atom qubit state based on the extracted quantum state information.
